(19) United States
(12) Patent Application Publication
(10) Pub. No.: US 2022/0049969 A1
(43) Pub. Date: Feb. 17, 2022

(54) NAVIGATION SYSTEM AND METHOD FOR CONTROLLING AND INTEGRATING NAVIGATION ROUTES

(71) Applicant: Tainan National University of the Arts, Tainan City (TW)

(72) Inventors: Yi-Ping Hung, Tainan City (TW); Jia-Wei Lin, New Taipei City (TW)

(21) Appl. No.: 17/089,383

(22) Filed: Nov. 4, 2020

(30) Foreign Application Priority Data
Aug. 13, 2020 (TW) 109127568

(51) Int. Cl. G01C 21/36; G06T 19/00

(52) U.S. Cl. CPC G01C 21/365; G06T 19/003; G01C 21/3638; G01C 21/3647

(57) ABSTRACT

Disclosed is a navigation system and method for controlling and integrating navigation routes. The system includes a server, a network, at least one control unit, and at least one virtual navigation device. The method includes steps of turning on the at least one virtual navigation device, downloading navigation images and contents, displaying the navigation images, receiving a control instruction, performing navigation, receiving a switch instruction, and switching a navigation route for implementing virtual navigation of integrated routes. Thus, the present invention provides the features of virtual reality and augmented reality, and the aspects of exclusive navigation and free discovery for the user to experience and easily switch the accompanying navigation mode and the free discovery mode.

### CROSS-REFERENCE TO RELATED APPLICATION

This application claims the priority of Taiwanese patent application No. 109127568, filed on Aug. 13, 2020, which is incorporated herewith by reference.

### BACKGROUND OF THE INVENTION

### 1. Field of the Invention

The present invention generally relates to a navigation system and method for controlling and integrating navigation routes, and more specifically to a navigation system and method employing a server, a network, at least one control unit, and at least one virtual navigation device in collocation with the schemes of virtual reality and augmented reality to combine and provide the aspects of exclusive navigation and free discovery for the user to experience and easily switch the accompanying navigation mode and the free discovery mode.

### 2. The Prior Arts

As the schemes of virtual reality and augmented reality have been constantly developed and made a great deal of progress, related fields of application and industries gradually expand. In addition to video game industry, such schemes have been also applied to other industries like movie, medication, and travel in need of navigation.

In the prior arts, the virtual reality navigation system usually provides home page or software program for the user to practically experience virtual navigation at the destination through controlling and operating a computer, mobile device, or head-mounted display. For example, virtual reality and augmented reality have been successfully employed in the process of real estate trade to help the buyer readily and remotely examine the status of the target real estate, or widely utilized in museum navigation to allow individual visitors in a museum to experience sense of presence and a realistic mood or atmosphere for the historical background.

In addition, the traditional virtual navigation system usually operates at a navigation mode or a free discovery mode. In the navigation mode, the image viewed by the user needs to dynamically change and update along the navigation route preset by the navigator, and at the same time, the user watches the image and hears the voice prepared by the navigator for introduction or explanation. In the free discovery mode, the user can change the view angle and position by inputting the appropriate control command or moving the navigation device.

However, the two modes of navigation in the prior arts have respective drawbacks. The drawback of the navigation mode is that the navigation route is fixed, and not allowed to switch or change according to individual preference during navigation. For the free discovery mode, while the view angle and position of the user and the navigation route can be updated as desired, the user fails to enjoy profound and exquisite description previously provided by the navigator.

Therefore, it is greatly needed to provide a new navigation system and method for controlling and integrating navigation routes, particularly employing the server, the network, the at least one control unit, and the at least one virtual navigation device in collocation with the schemes of virtual reality and augmented reality to allow the user to willingly and easily switch the accompanying navigation mode and the free discovery mode with the navigation routes, thereby overcoming the above problems in the prior arts.

### SUMMARY OF THE INVENTION

The primary object of the present invention is to provide a navigation system for controlling and integrating navigation routes comprising a server, a network, at least one control unit, and at least one virtual navigation device for implementing a function of virtual reality navigation.

Specifically, the server is connected to the network, and stores and sends a virtual reality image signal, an augmented reality image signal, a plurality of navigation routes, and a plurality of navigation contents. The virtual reality image signal is responsive to a virtual reality image, the augmented reality image signal is responsive to an augmented reality image, and the navigation contents comprise a text, a piece of audio, or an image.

All of the control units are connected to the server through the network for receiving and sending the virtual reality image signal, the augmented reality image signal, the navigation routes, and the navigation contents, and each control unit is provided with a user interface for the user to input and transfer the control command.

Each virtual navigation device is provided with an audio and video display function, and electrically connected to the responsive control unit for the user to wear, and at the same time, receives the control command, the virtual reality image signal, the augmented reality image signal, the navigation routes, and the navigation contents. Further, one of the navigation routes is selected as the current navigation route, and the virtual reality image, the augmented reality image, and the navigation content are displayed according to the current navigation route and the control command, thereby implementing the virtual navigation function.

Also, the above control command comprises a discovery mode switch command, a navigation route switch command, and an operation mode setting command. The discovery mode switch command is intended for switching an operation mode to a free discovery mode or a navigation mode. The free discovery mode is provided for the user to change an approaching direction to move forward and update the current navigation route according to the virtual reality image and the augmented reality image. Further, the navigation mode comprises a virtual reality navigation mode and an augmented reality navigation mode, and the operation mode setting command is intended to select one of the virtual reality navigation mode and the augmented reality navigation mode. Specifically, the virtual navigation device displays the virtual reality image when the operation mode is the virtual reality navigation mode, and the virtual navigation device displays the augmented reality image when the operation mode is the augmented reality navigation mode.

In particular, when the user switches the free discovery mode to the navigation mode through the discovery mode switch command, the navigation route switch command provides the user to keep the current navigation route without change or switch the current navigation route to one of the other navigation routes for updating the current navigation route, or alternatively, the virtual navigation device determines to keep the current navigation route without change or switch the current navigation route to one of the other navigation routes for updating the current navigation route.

In addition, another object of the present invention is to provide a navigation method for controlling and integrating navigation routes comprising the steps S10, S20, S30, S40, S50, S60, S70, and S80 for implementing a function of virtual reality navigation for various navigation routes.

In the step S10, the navigation method starts the at least one virtual navigation device, which is electrically connected to the at least one control unit, and the at least one control unit is further connected to the server through the network. The server stores and sends a virtual reality image signal, an augmented reality image signal, a plurality of navigation routes, and a plurality of navigation contents to the network. For example, the navigation contents comprise a text, a piece of audio, or an image. Also, the control unit comprises a user interface for an user to input and send a control command.

The above control command comprises a discovery mode switch command, a navigation route switch command, and an operation mode setting command. The discovery mode switch command is intended for switching an operation mode to a free discovery mode or a navigation mode, and the navigation mode comprises a virtual reality navigation mode and an augmented reality navigation mode, wherein the operation mode setting command is intended to select one of the virtual reality navigation mode and the augmented reality navigation mode.

In the step S20, the virtual navigation device downloads and receives the virtual reality image signal, the augmented reality image signal, the navigation routes, the navigation contents, and the control command from the server, and further selects one of the navigation routes as a current navigation route.

In the step S30, each of the at least one virtual navigation device provides the user to wear and displays a preset image, and in the step S40, each of the at least one virtual navigation device receives the control command from the respective control unit.

In the step S50, each of the at least one virtual navigation device executes a navigation process based on the control command, and the navigation process generally comprises the operation of displaying a virtual reality image responsive to the virtual reality image signal or a augmented reality image responsive to the augmented reality image signal according to the current navigation route. In the step S60, each of the at least one virtual navigation device further receives the control command input by the user, and in the step S70, each of the at least one virtual navigation device updates and switches the current navigation route to one of the other navigation routes when the control command is a navigation route switch command, and the navigation method then returns back to the step S50.

In the step S80, each of the at least one virtual navigation device switches the navigation mode ongoing to the free discovery mode, or switches the free discovery mode ongoing to the navigation mode when the control command is the discovery mode switch command, and specifically, the navigation route switch command provides the user to keep the current navigation route without change or switch the current navigation route to one of the other navigation routes for updating the current navigation route. Subsequently, the navigation method then returns back to the step S50.

Moreover, the virtual navigation device displays the virtual reality image when the operation mode is the virtual reality navigation mode, and the virtual navigation device displays the augmented reality image when the operation mode is the augmented reality navigation mode.

Therefore, the present invention employs the server, the network, the at least one control unit, and the at least one virtual navigation device in collocation with the schemes of virtual reality and augmented reality to allow the user to discover and navigate the navigation routes, thereby implementing the virtual navigation function for the navigation routes.

### BRIEF DESCRIPTION OF THE DRAWINGS

The present invention can be understood in more detail by reading the subsequent detailed description in conjunction with the examples and references made to the accompanying drawings, wherein:

FIG. 1 is a view showing the navigation system for controlling and integrating navigation routes according to the first embodiment of the present invention; and

FIG. 2 is a flowchart showing the navigation method for controlling and integrating navigation routes according to the second embodiment of the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

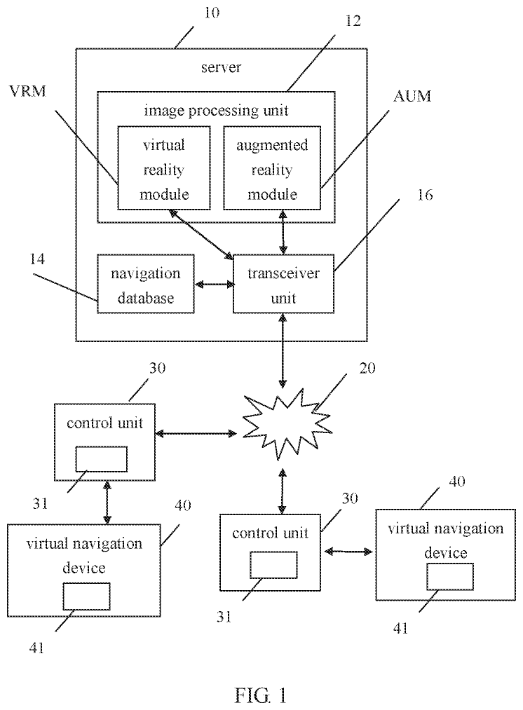

Please refer to FIG. 1 illustrating the system of navigation system for controlling and integrating navigation routes according to the first embodiment of the present invention. As shown in FIG. 1, the system of navigation system according to the first embodiment of the present invention generally comprises a server 10, a network 20, at least one control unit 30, and at least one virtual navigation device 40 for implementing a function of virtual reality navigation for various navigation routes. The server 10 is connected to the at least one control unit 30 through the network 20, and each of the at least one virtual navigation device 40 is provided with a virtual navigation function, and electrically connected to the responsive control unit 30 for providing the user to wear. It is preferred that the network 20 comprises a wireless network, and the control unit 30 and the virtual navigation device 40 are integrated together as a whole.

Specifically, the server 10 stores and sends a virtual reality image signal, an augmented reality image signal, a plurality of navigation routes, and a plurality of navigation contents. The virtual reality image signal is responsive to a virtual reality image, the augmented reality image signal is responsive to an augmented reality image, and the navigation contents comprise a text, a piece of audio, or an image.

Each control unit 30 receives and then sends the virtual reality image signal, the augmented reality image signal, the navigation routes, and the navigation contents, and in particular, each control unit 30 is provided with a user interface 31 for the user to input and transfer the control command.

Each virtual navigation device 40 is provided with an audio and video display function, and electrically connected to the responsive control unit 30 for the user to wear. At the same time, each virtual navigation device 40 receives the control command, the virtual reality image signal, the augmented reality image signal, the navigation routes, and the navigation contents from the control unit 30. Further, one of the navigation routes is selected as the current navigation route, and the virtual reality image, the augmented reality image, and the navigation content are displayed according to the current navigation route and the control command, thereby implementing the virtual navigation function.

Additionally, the above control command comprises a discovery mode switch command, a navigation route switch command, and an operation mode setting command. The discovery mode switch command is intended for switching an operation mode to a free discovery mode or a navigation mode. Further, the navigation mode comprises a virtual reality navigation mode and an augmented reality navigation mode, and the operation mode setting command is intended to select one of the virtual reality navigation mode and the augmented reality navigation mode.

Also, the free discovery mode is provided for the user to change an approaching direction to move forward and update the current navigation route according to the virtual reality image and the augmented reality image. Specifically, the virtual navigation device displays the virtual reality image when the operation mode is the virtual reality navigation mode, and the virtual navigation device displays the augmented reality image when the operation mode is the augmented reality navigation mode. Particularly, when the user switches the free discovery mode to the navigation mode through the discovery mode switch command, the navigation route switch command provides the user to keep the current navigation route without change or switch the current navigation route to one of the other navigation routes for updating the current navigation route, or alternatively, the virtual navigation device determines to keep the current navigation route without change or switch the current navigation route to one of the other navigation routes for updating the current navigation route.

For example, the above user interface 31 comprises a keyboard, a touch screen, a handheld control device, or a wearable control device. The keyboard, the handheld control device, or the wearable control device comprises at least one key for the user to press and generate the control command, and the virtual navigation device 40 comprises a smartphone, a head-mounted display, or a glasses display.

Further, the server 10 comprises an image processing unit 12, a navigation database 14, and a transceiver unit 16. The image processing unit 12 comprises a virtual reality module VRM and an augmented reality module AUM. The virtual reality module VRM stores and sends the virtual reality image signal to the transceiver unit 16, and the augmented reality module AUM stores and sends the augmented reality image signal to the transceiver unit 16. The navigation database 14 stores and sends the navigation routes and the navigation contents to the transceiver unit 16, and the transceiver unit 16 is connected to the network 20 and transmits the virtual reality image signal, the augmented reality image signal, the navigation routes, and the navigation contents to the network 20 to the control unit 30.

More specifically, the control command input by the user through the user interface 31 further comprises the operation mode setting command for setting the operation mode, and the operation mode comprises the virtual reality navigation mode and the augmented reality navigation mode. The virtual navigation device 40 displays the virtual reality image when the operation mode is the virtual reality navigation mode, and the virtual navigation device 40 displays the augmented reality image when the operation mode is the augmented reality navigation mode. In particular, the virtual reality navigation mode is suitable for on-line virtual navigation, and the augmented reality navigation mode is suitable for virtual navigation on the scene.

In other words, when the user is not on the scene of navigation like in a remote room or an outdoor environment, the user interface 31 is employed to select the virtual reality navigation mode, and the virtual navigation device 40 displays the virtual reality image and the navigation content such that the user indeed in vision experiences a view moving along the navigation route at a preset pace, as well as listens to the navigation content for introduction and explanation of the navigation subjects, thereby strongly impressed and well understanding,

Further, the virtual navigation device 40 comprises a positioning element 41 for transmitting a positioning information to the server 10, and the positioning element 41 is preferably one of a global positioning system (GPS) element, a near field communication (NFC) element, a radio frequency identification (RFID element, a WiFi element, a Bluetooth element, and a two-dimensional barcode scanning element. The server 10 transmits one of the navigation contents according to the positioning information when the virtual navigation device 40 is in the augmented reality navigation mode as the operation mode, and displays a position responsive to the positioning information.

Also, the virtual navigation device 40 determines whether the user deviates from the current navigation route or not when the operation mode is the augmented reality navigation mode, and the virtual navigation device 40 further provides a guiding prompt to guide the user back to the current navigation route when the user deviates from the current navigation route. For instance, the guiding prompt comprises at least one of a guiding text, a guiding icon, a piece of guiding voice, and a guiding light sign.

In addition, if the user is on the scene of navigation, the user interface 31 is employed to select the augmented reality mode, and the virtual navigation device 40 displays the augmented reality image and the navigation content. At this time, the augmented reality image and the navigation content are able to enhance sense of presence for the user, or the navigation content in a preset manner or as the user's movement on the navigation scene dynamically prompts the user to take notice of the shape, color, size, position, or direction of certain specific exhibits, objects, or landmarks in the vicinity for easy search and identification.

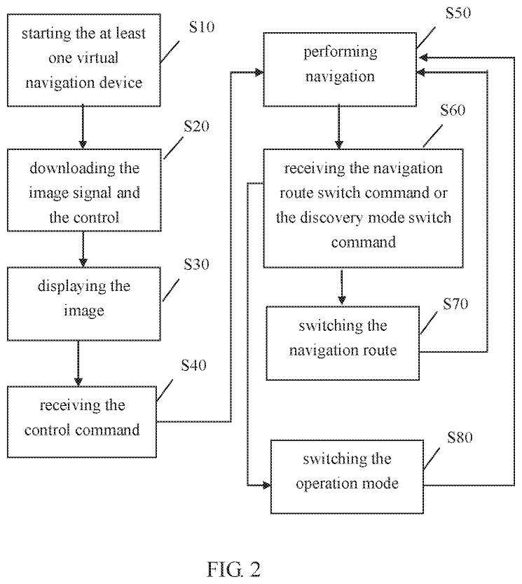

Furthermore, refer to FIG. 2 illustrating the navigation method for controlling and integrating navigation routes according to the second embodiment of the present invention. As shown in FIG. 2, the navigation method according to the second embodiment of the present invention comprises the steps S10, S20, S30, S40, S50, S60, S70, and S80 for implementing a function of virtual reality navigation for various navigation routes. It should be noted that the navigation method of the present invention generally employs a server 10, a network 20, at least one control unit 30, and at least one virtual navigation device 40 as shown in FIG. 1 to implement the navigation function as desired, and it is feasible to refer to FIG. 1 for clearly understanding the features of the second embodiment according to the present invention. Since the aspects of the server 10, the network 20, the control unit 30, and the virtual navigation device 40 are well explained above, detailed description is omitted hereinafter.

First, the navigation method of the second embodiment begins at the step S10 to start the at least one virtual navigation device electrically connected to the at least one control unit, and the at least one control unit is further connected to the server through the network. Further, the server stores and sends a virtual reality image signal, an augmented reality image signal, a plurality of navigation routes, and a plurality of navigation contents to the network, and the navigation contents comprise a text, a piece of audio, or an image. Also, the control unit comprises a user interface for the user to input and send a control command.

Specifically, the above control command comprises a discovery mode switch command, a navigation route switch command, and an operation mode setting command. The discovery mode switch command is intended for switching an operation mode to a free discovery mode or a navigation mode, and the navigation mode comprises a virtual reality navigation mode and an augmented reality navigation mode, wherein the operation mode setting command is intended to select one of the virtual reality navigation mode and the augmented reality navigation mode.

In the step S20, the virtual navigation device is able to download and receive the virtual reality image signal, the augmented reality image signal, the navigation routes, the navigation contents, and the control command from the server, and further selects one of the navigation routes as a current navigation route.

Then, the step S30 is performed by each of the at least one virtual navigation device providing the user to wear and displaying a preset image as a power-on image such as a home page of introducing virtual navigation introduction for rough introduction and effectively helping the user fast get familiar with the operation environment.

In the step S40, each of the at least one virtual navigation device receives the control command from the respective control unit, and the control command is input by the user through the user interface of the control unit.

In the step S50, each of the at least one virtual navigation device executes a navigation process based on the control command, and the navigation process generally comprises the operation of displaying a virtual reality image responsive to the virtual reality image signal or a augmented reality image responsive to the augmented reality image signal according to the current navigation route. In the step S60, each of the at least one virtual navigation device further receives the control command input by the user. If the control command is the navigation route switch command, enters the step S70, and if the control command is the discovery mode switch command, the step S80 is performed.

In the step S70, each of the at least one virtual navigation device updates and switches the current navigation route to one of the other navigation routes. For example, the navigation route switch command is intended to switch the current navigation route to the next one navigation route at a time, and the user thus selects a preferred navigation route by gradually invoking a plurality times for the navigation route switch command. Then, the navigation method returns back to the step S50 for performing the subsequent operations.

In the step S80, the virtual navigation device switches the navigation mode ongoing to the free discovery mode, or switches the free discovery mode ongoing to the navigation mode, and specifically, the navigation route switch command provides the user to keep the current navigation route without change or switch the current navigation route to one of the other navigation routes for updating the current navigation route. Subsequently, the navigation method then returns back to the step S50.

Further, the virtual navigation device displays the virtual reality image when the operation mode is the virtual reality navigation mode, and the virtual navigation device displays the augmented reality image when the operation mode is the augmented reality navigation mode. Thus, the virtual reality navigation mode is appropriate for on-line virtual reality navigation, and the augmented reality navigation mode is appropriate for on-line augmented reality navigation.

From the above mentioned, the aspect of the present invention is that the control unit receives the control command input by the user like navigation route information, and the user is allowed to select and switch the current navigation route at a connection of two different navigation routes. Additionally, the server receives the control command from the control unit to responsively output the virtual reality image signal, the augmented reality image signal, and the navigation content, and the control unit receives and further transmits the virtual reality image signal, the augmented reality image signal, and the navigation content to the virtual navigation device. Thus, the user can experience image and sound for virtual reality and augmented reality by wearing or carrying the virtual navigation device.

Overall, the present invention integrates the navigation routes and specifically combines the schemes of virtual reality and augmented reality to provide the user to select one of the navigation routes for virtual reality or augmented reality in the free discovery mode or the navigation mode, and freely switch between the free discovery mode and the navigation mode.

Another aspect of the present invention is that on-line virtual reality navigation and augmented reality navigation are readily provided for the user to select for practical need.

The preferred operation for on-line virtual reality navigation and augmented reality navigation exemplarily comprises: starting one or more than one virtual navigation device to download and receive the virtual reality image signal from the server through the network, and further display the virtual reality image based on the position and direction parameter; and then, the user inputting the control command to select and change the current navigation route to download the responsive navigation content. Therefore, when the navigation proceeds to the connection of two different navigation routes, the user can freely select and switch the navigation route.

Furthermore, the augmented reality navigation comprises: the user employing the handheld mobile device to fetch the navigation content for augmented reality when the user is actually in the navigation space; the handheld mobile device comprising the positioning element; the server sending the navigation content according to the positioning information, and displaying the correct position responsive to the object on the scene; and the user accordingly selecting the navigation route, and easily switching the current navigation route at the connection of two different navigation routes.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A navigation system for controlling and integrating navigation routes to implement a function of virtual navigation, comprising:
a server connected to a network, storing and sending a virtual reality image signal, an augmented reality image signal, a plurality of navigation routes, and a plurality of navigation contents, the virtual reality image signal responsive to a virtual reality image, the augmented reality image signal responsive to an augmented reality image, the navigation contents comprise a text, a piece of audio, or an image;
at least one control unit connected to the server through the network for receiving and transmitting the virtual reality image signal, the augmented reality image signal, the navigation routes, and the navigation contents, the control unit comprising an user interface for an user to input and send a control command; and
at least one virtual navigation device, each of the virtual navigation device provided with a function of audio and video display and electrically connect to the respective control unit for the user to wear and receive the control command, the virtual reality image signal, the augmented reality image signal, the navigation routes, and the navigation contents, the virtual navigation device providing the user to select one of the navigation routes as a current navigation route and display the virtual reality image, the augmented reality image, and the navigation contents based on the current navigation route and the control command for the function of virtual navigation,
wherein the control command comprises a discovery mode switch command, a navigation route switch command, and an operation mode setting command,
the discovery mode switch command is intended for switching an operation mode to a free discovery mode or a navigation mode,
the free discovery mode is provided for the user to change an approaching direction to move forward and update the current navigation route according to the virtual reality image and the augmented reality image,
the navigation mode comprises a virtual reality navigation mode and an augmented reality navigation mode,
the operation mode setting command is intended to select one of the virtual reality navigation mode and the augmented reality navigation mode,
the virtual navigation device displays the virtual reality image when the operation mode is the virtual reality navigation mode, and
the virtual navigation device displays the augmented reality image when the operation mode is the augmented reality navigation mode,
wherein when the user switches the free discovery mode to the navigation mode through the discovery mode switch command, the navigation route switch command provides the user to keep the current navigation route without change or switch the current navigation route to one of the other navigation routes for updating the current navigation route, or alternatively, the virtual navigation device determines to keep the current navigation route without change or switch the current navigation route to one of the other navigation routes for updating the current navigation route.

2. The navigation system as claimed in claim 1, wherein the user interface comprises a keyboard, a touch screen, a handheld control device, or a wearable control device, the keyboard, the handheld control device, or the wearable control device comprises at least one key for the user to press and generate the control command, and the virtual navigation device comprises a smartphone, a head-mounted display, or a glasses display.

3. The navigation system as claimed in claim 1, wherein the server comprises an image processing unit, a navigation database, and a transceiver unit, the image processing unit comprises a virtual reality module and an augmented reality module, the virtual reality module stores and sends the virtual reality image signal to the transceiver unit, the augmented reality module stores and sends the augmented reality image signal to the transceiver unit, the navigation database stores and sends the navigation routes and the navigation contents to the transceiver unit, and the transceiver unit is connected to the network and transmits the virtual reality image signal, the augmented reality image signal, the navigation routes, and the navigation contents to the network.

4. The navigation system as claimed in claim 3, wherein the virtual navigation device comprises a positioning element for transmitting a positioning information to the server, the positioning element is one of a global positioning system (GPS) element, a near field communication (NFC) element, a radio frequency identification (RFID element, a WiFi element, a Bluetooth element, and a two-dimensional barcode scanning element, and the server transmits one of the navigation contents according to the positioning information when the virtual navigation device is in the augmented reality navigation mode as the operation mode, and displays a position responsive to the positioning information.

5. The navigation system as claimed in claim 4, wherein the virtual navigation device determines whether the user deviates from the current navigation route or not when the operation mode is the augmented reality navigation mode, the virtual navigation device provides a guiding prompt to guide the user back to the current navigation route when the user deviates from the current navigation route, and the guiding prompt comprises at least one of a guiding text, a guiding icon, a piece of guiding voice, and a guiding light sign.

6. The navigation system as claimed in claim 1, wherein the virtual navigation device and the control unit are integrated together as a whole.

7. A navigation method for controlling and integrating navigation routes to implement a function of virtual navigation in collocation with a server, a network, at least one control unit, and at least one virtual navigation device, comprising:
a step S10, starting the at least one virtual navigation device electrically connected to the at least one control unit, the at least one control unit further connected to the server through the network,
the server storing and sending a virtual reality image signal, an augmented reality image signal, a plurality of navigation routes, and a plurality of navigation contents to the network,
the navigation contents comprising a text, a piece of audio, or an image,
the control unit comprising an user interface for an user to input and send a control command,
the control command comprising a discovery mode switch command, a navigation route switch command, and an operation mode setting command,
the discovery mode switch command intended for switching an operation mode to a free discovery mode or a navigation mode,
the navigation mode comprising a virtual reality navigation mode and an augmented reality navigation mode,
the operation mode setting command intended to select one of the virtual reality navigation mode and the augmented reality navigation mode;
a step S20, the at least one virtual navigation device downloading and receiving the virtual reality image signal, the augmented reality image signal, the navigation routes, the navigation contents, and the control command from the server, and selecting one of the navigation routes as a current navigation route;
a step S30, each of the at least one virtual navigation device providing the user to wear and displaying a preset image;
a step S40, each of the at least one virtual navigation device receiving the control command from the respective control unit;
a step S50, each of the at least one virtual navigation device executing a navigation process based on the control command, the navigation process comprising displaying a virtual reality image responsive to the virtual reality image signal, or displaying a augmented reality image responsive to the augmented reality image signal according to the current navigation route;
a step S60, each of the at least one virtual navigation device receiving the control command input by the user;
a step S70, each of the at least one virtual navigation device updating and switching the current navigation route to one of the other navigation routes when the control command being a navigation route switch command, and then returning back to the step S50; and
a step S80, each of the at least one virtual navigation device switching the navigation mode ongoing to the free discovery mode, or switching the free discovery mode ongoing to the navigation mode when the control command being the discovery mode switch command, the navigation route switch command providing the user to keep the current navigation route without change or switch the current navigation route to one of the other navigation routes for updating the current navigation route, then returning back to the step S50,
wherein the virtual navigation device displays the virtual reality image when the operation mode is the virtual reality navigation mode, and the virtual navigation device displays the augmented reality image when the operation mode is the augmented reality navigation mode.

8. The navigation method as claimed in claim 7, wherein the user interface comprises a keyboard, a touch screen, a handheld control device, or a wearable control device, the keyboard, the handheld control device, or the wearable control device comprises at least one key for the user to press and generate the control command, and the virtual navigation device comprises a smartphone, a head-mounted display, or a glasses display.

9. The navigation method as claimed in claim 7, wherein the server comprises an image processing unit, a navigation database, and a transceiver unit, the image processing unit comprises a virtual reality module and an augmented reality module, the virtual reality module stores and sends the virtual reality image signal to the transceiver unit, the augmented reality module stores and sends the augmented reality image signal to the transceiver unit, the navigation database stores and sends the navigation routes and the navigation contents to the transceiver unit, and the transceiver unit is connected to network and transmits the virtual reality image signal, the augmented reality image signal, the navigation routes, and the navigation contents to the network.

10. The navigation method as claimed in claim 9, wherein the virtual navigation device comprises a positioning element for transmitting a positioning information to the server, the positioning element is one of a global positioning system (GPS) element, a near field communication (NFC) element, a radio frequency identification (RFID element, a WiFi element, a Bluetooth element, and a two-dimensional barcode scanning element, and the server transmits one of the navigation contents according to the positioning information when the virtual navigation device is in the augmented reality navigation mode as the operation mode, and displays a position responsive to the positioning information.

11. The navigation method as claimed in claim 10, wherein the virtual navigation device determines whether the user deviates from the current navigation route or not when the operation mode is the augmented reality navigation mode, the virtual navigation device provides a guiding prompt to guide the user back to the current navigation route when the user deviates from the current navigation route, and the guiding prompt comprises at least one of a guiding text, a guiding icon, a piece of guiding voice, and a guiding light sign.

12. The navigation method as claimed in claim 7, wherein the virtual navigation device and the control unit are integrated together as a whole.
